(19) United States
(12) Patent Application Publication
(10) Pub. No.: US 2017/0057397 A1
(43) Pub. Date: Mar. 2, 2017

(54) Bungee Cord

(71) Applicant: Kwong Wah Rubber Factory Limited, New Territories (HK)

(72) Inventor: Tony Kit Wing Leung, New Territories (HK)

(73) Assignee: KWONG WAH RUBBER FACTORY LIMITED, New Territories (HK)

(21) Appl. No.: 14/843,813

(22) Filed: Sep. 2, 2015

(51) Int. Cl. B60P 7/08; F16B 45/00

(52) U.S. Cl. CPC B60P 7/0823; F16B 45/00

(57) ABSTRACT

A bungee cord comprises a body (3) and a terminus (2) detachably mounted on an end portion of the body (3); and the terminus (2) includes a gripping portion (8); a fixing hole (83) and a cord hole (84) are defined in the gripping portion (8); and the cord hole (84) communicates with the fixing hole (83); and the body (3) is arranged in the cord hole (84), and fixed by a pin, nail or screw (4) detachably arranged in the fixing hole (83). The body of bungee cord can be removed from the terminus; and the bungee cord can be gripped via the gripping portion. The bungee cord has a simple structure, and good practicality.

### FIELD OF THE INVENTION

The present application relates to a bungee cord; and the bungee cord comprises a round or flat, multi-core or single-core body which is anchored into a molded terminus by a transverse pin, nail or screw; and the transverse pin, nail or screw is fastened through the body at an aperture in the molded terminus.

### BACKGROUND OF THE INVENTION

Bungee cords are typically used for a wide variety of means to secure or restrict the movement of an object such as cargo and the like. Almost all of bungee cords comprise a body and a terminus mounted on an end portion of the body. The most simple and common terminus is a stiff wire hook, which is bent into a coiled wire basket. The body is fed into the wire basket and folded back on itself to form a loop, so that a movement of the body is restricted within the terminus at one end portion.

In another case, one end portion of the body is tied in a knot or folded back on itself to form a loop mounted on a terminus, and the loop is molded together with the terminus. The body may also be looped through an eye formed in a terminus, and molded together with the terminus

The aforementioned technical solutions result in that the end portion of the bungee cord is permanently molded into the terminus, and can't be removed without damaging the terminus.

### SUMMARY OF THE INVENTION

The objective of the present application is to provide a bungee cord that comprises a round or flat, multi-core or single-core body which is anchored into a molded terminus by a transverse pin, nail or screw, aiming at the defect that an end portion of a bungee cord in prior art is permanently molded into the terminus, and can't be removed without damaging the terminus.

The technical solutions of the present application for solving the technical problems are as follows.

In one aspect, a bungee cord comprising a body and a terminus detachably mounted on an end portion of the body is provided.

In one embodiment, the terminus includes a gripping portion; a fixing hole and a cord hole are defined in the gripping portion; and the cord hole communicates with the fixing hole; and the body is arranged in the cord hole, and fixed by a pin, nail or screw detachably arranged in the fixing hole.

In another embodiment, a gripping recess is defined in the gripping portion; and several protruding points are arranged on the bottom of the gripping recess; and the fixing hole is defined in the bottom of the gripping recess.

In another embodiment, some gripping ribs are arranged on the gripping portion.

In another embodiment, the terminus includes a hook, and the hook is connected to the gripping portion.

In another embodiment, the bungee cord further includes a framework, and the framework includes a loop and a hook core integral with the loop; a hook cover and the hook core wrapped in the hook cover cooperatively form the hook; the loop is covered by a molded element to form the gripping portion; and when the body is arranged in the cord hole, the body is also arranged in the loop; the hook cover is integral with the molded element.

In another embodiment, the bungee cord further includes a framework, and the framework includes a loop and a hook core; and the hook core includes a bending portion and a straight line portion integral with the bending portion; and the loop is connected to the straight line portion via a connecting filament; a hook cover and the hook core wrapped in the hook cover cooperatively form the hook; the loop and the connecting filament are covered by a molded element to form the gripping portion; the hook cover is integral with the molded element.

In another embodiment, the bungee cord further includes a framework, and the framework includes a hook core; and the hook core includes a bending portion and a straight line portion integral with the bending portion; the framework further includes a connecting board mounted on the straight line portion of the hook core; and a through-hole is defined in the connecting board; the body is arranged in the cord hole, and fixed by a pin, nail or screw detachably arranged in the fixing hole and the through-hole.

When implementing the bungee cord of the present application, the following advantageous effects can be achieved: the body of bungee cord can be removed from the terminus; and the bungee cord can be gripped via the gripping portion. The bungee cord has a simple structure, and good practicality.

### BRIEF DESCRIPTION OF THE DRAWINGS

The present application will be further described with reference to the accompanying drawings and embodiments in the following, in the accompanying drawings:

FIG. 1 is a perspective schematic view of a bungee cord of a first embodiment of the present application;

FIG. 2 is an exploded schematic view of the bungee cord shown in FIG. 1;

FIG. 3 is a perspective schematic view of a bungee cord of a second embodiment of the present application;

FIG. 4 is an exploded schematic view of a bungee cord of a third embodiment of the present application;

FIG. 5 is a schematic view of the hook 5 of the third embodiment of the present application;

FIG. 6 is a schematic view of the gripping portion 8 of the third embodiment of the present application;

FIG. 7 is a schematic view of a framework 6 of a fourth embodiment of the present application; and

FIG. 8 is a schematic view of a framework 6 of a fifth embodiment of the present application.

### DETAILED DESCRIPTION OF THE PREFERRED EMBODIMENT

The objective of the present application is to provide a bungee cord that comprises a round or flat, multi-core or single-core body which is anchored into a molded terminus by a transverse pin, nail or screw, aiming at the defect that an end portion of a bungee cord in prior art is permanently molded into the terminus, and can't be removed without damaging the terminus.

To make the technical feature, objective and effect of the present application be understood more clearly, now the specific implementation of the present application is described in detail with reference to the accompanying drawings and embodiments.

### First Embodiment

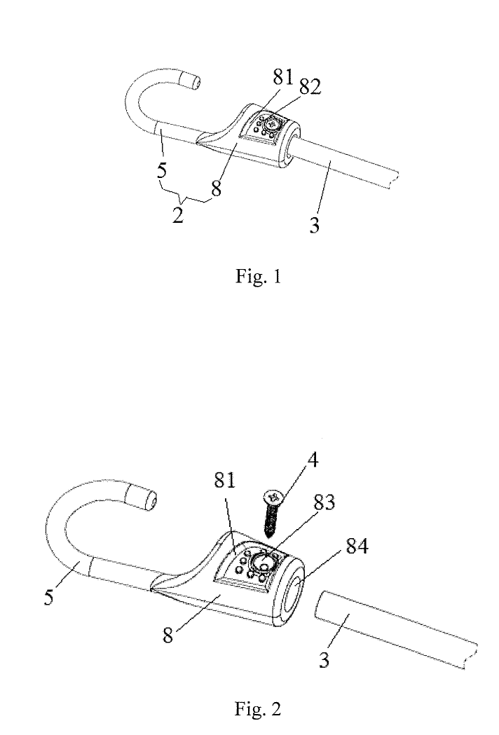

As shown in FIG. 1, FIG. 1 is a perspective schematic view of a bungee cord of a first embodiment of the present application;

In FIG. 1, the bungee cord comprises a body 3 and a terminus 2 detachably mounted on an end portion of the body 3.

The body 3 may be round or flat, multi-core or single core, and the terminus 2 may be of any appropriate shape, size or material. In the present embodiment, in FIG. 1, the terminus 2 includes a gripping portion 8, and a gripping recess 81 is defined in the gripping portion 8. Users can grip the terminus 2 via the gripping recess 81 of the gripping portion 8. In order to improve a gripping effect, several protruding points 82 are arranged on the bottom of the gripping recess 81. Besides, the gripping portion 8 is made of polypropylene or similar plastics.

Furthermore, in the present application, in FIG. 1, the terminus 2 includes a hook 5, and the hook 5 is integral with the gripping portion 8. It can be understood that the hook 5 can be assembled on the gripping portion 8 via a gluing process or a welding process, etc. in another embodiment. Besides, in the present application, the hook 5 may be of any appropriate shape, size or configuration, and of the same material as the gripping portion 8.

As shown in Fig, 2, FIG. 2 is an exploded schematic view of the bungee cord shown in FIG. 1.

In FIG. 2, a fixing hole 83 is defined in the bottom of the gripping recess 81; and a cord hole 84 is defined in the gripping portion 8, and communicates with the fixing hole 83. In the present application, the cord hole 84 is located in an end portion of the gripping portion 8, which is far away from the hook 5. Besides, the body 3 is arranged in the cord hole 84, and fixed by a pin, nail or screw 4 detachably arranged in the fixing hole 83. The pin, nail or screw 4 may be of any appropriate shape, size, or material. Thus, after the pin, nail or screw 4 is removed from the gripping portion 8, the body 3 can be removed from the gripping portion 8.

### Second Embodiment

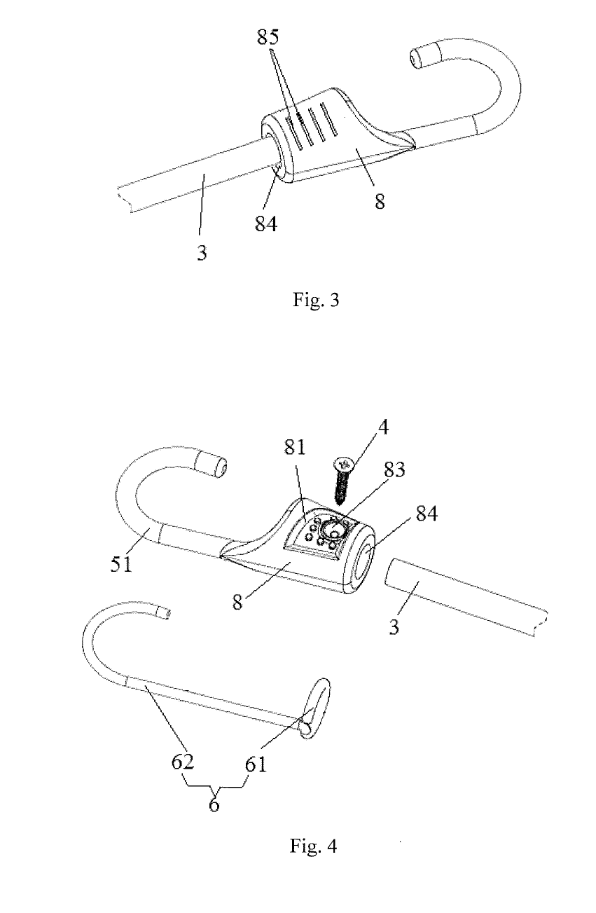

As shown in FIG. 3, FIG. 3 is a perspective schematic view of a bungee cord of a second embodiment of the present application;

The difference between bungee cords of the second embodiment and first embodiment lies in the gripping portion 8.

In the present embodiment, in FIG. 3, some gripping ribs 85 are arranged on a side portion of the gripping portion 8 to improve a gripping effect; and the fixing hole 83 (not shown) is defined in the other side portion of the gripping portion 8; and a cord hole 84 is defined in the gripping portion 8, and communicates with the fixing hole 83. Besides, the body 3 is arranged in the cord hole 84, and fixed by a pin, nail or screw 4 (not shown) detachably arranged in the fixing hole 83. Thus, after the pin, nail or screw 4 is removed from the gripping portion 8, the body 3 can be removed from the gripping portion 8.

### Third Embodiment

As shown in FIG. 4, FIG. 4 is an exploded schematic view of a bungee cord of a third embodiment of the present application;

The difference between bungee cords of the first embodiment and the third embodiment lies in structures of the gripping portion 8 and the hook 5.

In the present embodiment, in FIG. 4, the bungee cord further includes a framework 6, and the framework 6 includes a loop 61 and a hook core 62 integral with the loop 61. The framework 6 can be made of any appropriate material such as plastics or metals; advantageously, the framework 6 is made of steel to strengthen the hook 5.

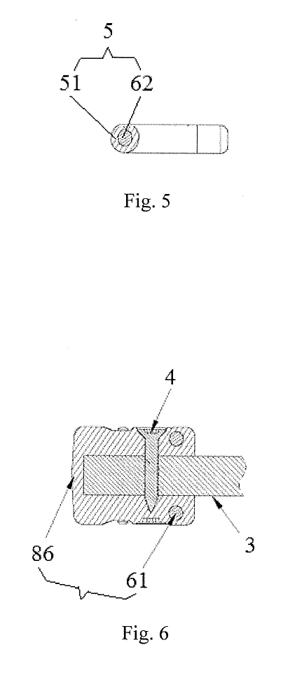

As shown in FIG. 5, FIG. 5 is a schematic view of the hook 5 of the third embodiment of the present application;

In FIG. 5, a hook cover 51 and the hook core 62 wrapped in the hook cover 51 cooperatively form the hook 5;

As shown in FIG. 6, FIG. 6 is a schematic view of the gripping portion 8 of the third embodiment of the present application;

In FIG. 6, the loop 61 is covered by a molded element 86 to form the gripping portion 8; and when the body 3 is arranged in the cord hole 84, the body 3 is also arranged in the loop 61.

In the present embodiment, the hook cover 51 is integral with the molded element 86.

### Fourth Embodiment

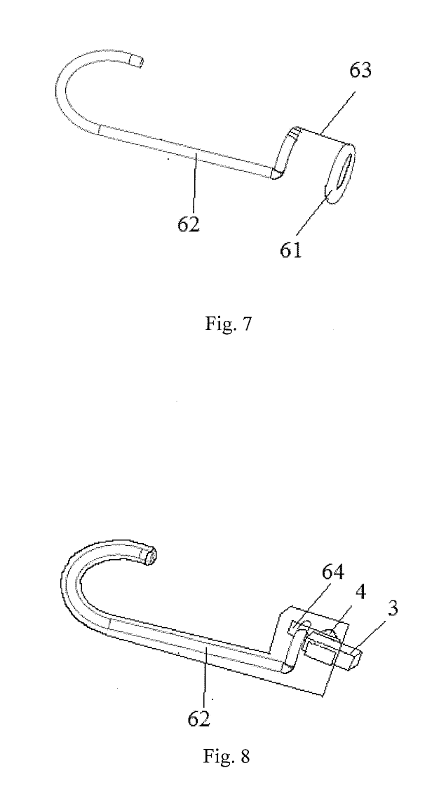

As shown in FIG. 7, FIG. 7 is a schematic view of a framework 6 of a fourth embodiment of the present application;

The difference between bungee cords of the third embodiment and the fourth embodiment lies in structure of the framework 6.

In the present embodiment, in FIG. 7, the loop 61 isn't integral with the hook core 62, and is connected to the hook core 62 via a connecting filament 63.

Furthermore, the hook core 62 includes a bending portion and a straight line portion integral with the bending portion, and the loop 61 is connected to the straight line portion via the connecting filament 63. Besides, the loop 61 and the connecting filament 63 are covered by a molded element 86 to form the gripping portion 8.

The strength of the bungee cord of the present embodiment can be improved via the framework 6.

### Fifth Embodiment

As shown in FIG. 8, FIG. 8 is a schematic view of a framework 6 of a fifth embodiment of the present application;

The difference between bungee cords of the fifth embodiment and the fourth embodiment lies in structure of the framework 6.

In the present embodiment, in FIG. 8, the loop 61 and the connecting filament 63 don't exist, and the framework 6 further includes a connecting board 64 mounted on the straight line portion of the hook core 62; and a through-hole (not shown) is defined in the connecting board 64.

The body 3 is arranged in the cord hole 84, and fixed by a pin, nail or screw 4 detachably arranged in the fixing hole 83 (not shown) and the through-hole. Advantageously, the body 3 is flat.

In the present application, the body of bungee cord can be removed from the terminus; and the bungee cord can be gripped via the gripping portion. The bungee cord has a simple structure, and good practicality.

While the embodiments of the present application are described with reference to the accompanying drawings above, the present application is not limited to the above-mentioned specific implementations. In fact, the above-mentioned specific implementations are intended to be exemplary not to be limiting. In the inspiration of the present application, those ordinary skills in the art can also make many modifications without breaking away from the subject of the present application and the protection scope of the claims. All these modifications belong to the protection of the present application.

What is claimed is:

1. A bungee cord, comprising a body (3) and a terminus (2) detachably mounted on an end portion of the body (3).

2. The bungee cord according to claim 1, wherein the terminus (2) includes a gripping portion (8); a fixing hole (83) and a cord hole (84) are defined in the gripping portion (8); and the cord hole (84) communicates with the fixing hole (83); and the body (3) is arranged in the cord hole (84), and fixed by a pin, nail or screw (4) detachably arranged in the fixing hole (83).

3. The bungee cord according to claim 2, wherein a gripping recess (81) is defined in the gripping portion (8); and several protruding points (82) are arranged on the bottom of the gripping recess (81); and the fixing hole (83) is defined in the bottom of the gripping recess (81).

4. The bungee cord according to claim 2, wherein some gripping ribs (85) are arranged on the gripping portion (8).

5. The bungee cord according to claim 2, wherein the terminus (2) includes a hook (5), and the hook (5) is connected to the gripping portion (8).

6. The bungee cord according to claim 5, wherein the bungee cord further includes a framework (6), and the framework (6) includes a loop (61) and a hook core (62) integral with the loop (61); a hook cover (51) and the hook core (62) wrapped in the hook cover (51) cooperatively form the hook (5); the loop (61) is covered by a molded element (86) to form the gripping portion (8); and when the body (3) is arranged in the cord hole (84), the body (3) is also arranged in the loop (61); the hook cover (51) is integral with the molded element (86).

7. The bungee cord according to claim 5, wherein the bungee cord further includes a framework (6), and the framework (6) includes a loop (61) and a hook core (62); and the hook core (62) includes a bending portion and a straight line portion integral with the bending portion; and the loop (61) is connected to the straight line portion via a connecting filament (63); a hook cover (51) and the hook core (62) wrapped in the hook cover (51) cooperatively form the hook (5); the loop (61) and the connecting filament (63) are covered by a molded element (86) to form the gripping portion (8); the hook cover (51) is integral with the molded element (86).

8. The bungee cord according to claim 5, wherein the bungee cord further includes a framework (6), and the framework (6) includes a hook core (62); and the hook core (62) includes a bending portion and a straight line portion integral with the bending portion; the framework (6) further includes a connecting board (64) mounted on the straight line portion of the hook core (62); and a through-hole is defined in the connecting board (64); the body (3) is arranged in the cord hole (84), and fixed by a pin, nail or screw (4) detachably arranged in the fixing hole (83) and the through-hole.
